(19) United States
(12) Patent Application Publication
(10) Pub. No.: US 2005/0279773 A1
(43) Pub. Date: Dec. 22, 2005

(54) Spray aid

(76) Inventor: Lamar Jermain Byrd, Palms, CA (US)

Correspondence Address: LAMAR J. BYRD, P. O. BOX 6296, 29 PALMS, CA, 92278, US

(21) Appl. No.: 10/869,364

(22) Filed: Jun. 17, 2004

(51) Int. Cl. B67D 5/58

(52) U.S. Cl. 222/382; 222/136

(57) ABSTRACT

The Spray Aid is like no other, having four legs created by the holding holes at the end of the plastic casing. Reaching the complete inter circumference of any bottle (circle, oval, or rectangular) base shape, pulling the liquid out of the bottle while in an upright or any tilted (left, right, up, or down) position. Enabling the user to have the freedom of holding their bottle in any position, while utilizing all of the liquid contained therein. The user never has to waste unused liquid again, will all be pulled out from any angle using The Spray Aid. The Spray Aid will universalize the use of spray bottles forever.

### CROSS-REFERENCE OF RELATED APPLICATIONS

Not Applicable

### STATEMENT REGARDING FEDERALLY SPONSORED RESEARCH OR DEVELOPMENT

Not Applicable

### REFERENCE OF SEQUENCE LISTING, A TABLE, OR A COMPUTER PROGRAM LISTING COMPACT DISK APPENDIX

Not Applicable

### BACKGROUND OF THE INVENTION

Field of Invention

This invention relates to all household spray bottles.

### BRIEF SUMMARY OF THE INVENTION

The Spray Aid will be made in varies sizes (different lengths of tubes), enabling liquids to be sprayed out of any bottle (circle, oval, or rectangular) base shape, in an upright or any tilted (left, right, up, or down) position. It is four tubes inside of a clear plastic casing with holding holes at the end of it. Positioned to pull the liquid from the complete inter circumference of the bottle.

### BRIEF DESCRIPTION OF THE SEVERAL VIEWS OF THE DRAWING

FIG. 1, is a drawing pointing out all the parts and features of the invention;

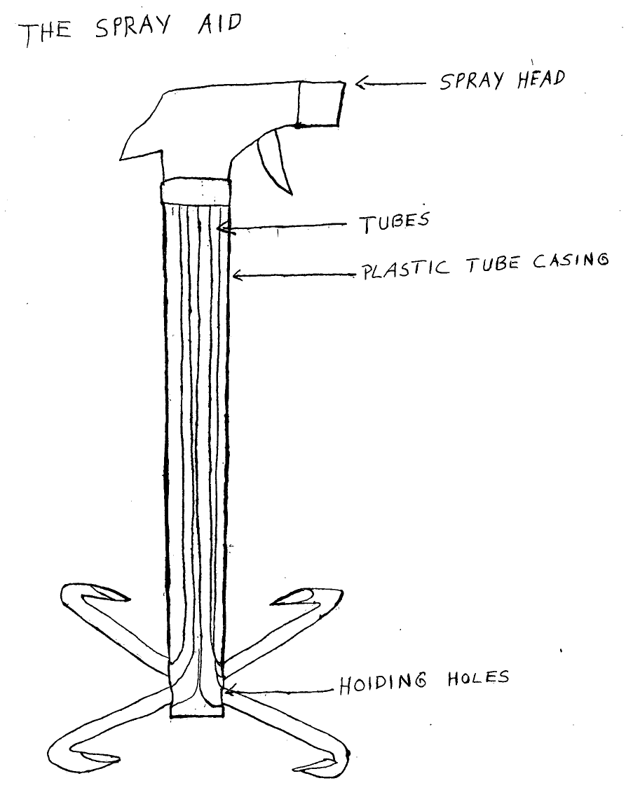

### DETAILED DESCRIPTION OF THE INVENTION

The Spray Aid is a sprayer head, with four flexible plastic tubes with pre-manufactured bends attached to it, having curved endings, which are slanted down at the tube opening. The four tubes are held in place at the end by the holding holes at the end of the plastic casing. It will be made in varies sizes (length of tubes), enabling liquids to be sprayed out of any bottle (circle, oval, or rectangular) base shape, in an upright or any tilted (left, right, up, or down) position. Simply squeeze the four flexible plastic legs, together, and insert into the bottle opening and release. The Spray Aid legs will open up to their true form once released. It is positioned to pull the liquid from the complete inter circumference of the bottle optimizing the use of the liquid contained therein.

1. What I claim as my invention is the spray aid, having four plastic tubes with curved endings, which are slanted down at the tube opening, inside of a clear plastic casing with holding holes at the end of the plastic casing. Enabling the user to spray liquids out of any bottle (circle, Oval, or rectangular) base shape, in a upright or any tilted (left, right, up, or down) position.
